(19) United States
(12) Patent Application Publication
(10) Pub. No.: US 2025/0229454 A1
(43) Pub. Date: Jul. 17, 2025

(54) FIBERBOARD STRUCTURE MANUFACTURING METHOD, FIBERBOARD STRUCTURE MANUFACTURING SYSTEM, AND FIBERBOARD STRUCTURE

(71) Applicant: FUJIFILM Corporation, Tokyo (JP)

(72) Inventor: Tadashi KYOSO, Kanagawa (JP)

(73) Assignee: FUJIFILM Corporation, Tokyo (JP)

(21) Appl. No.: 18/991,699

(22) Filed: Dec. 23, 2024

(30) Foreign Application Priority Data
Jan. 17, 2024 (JP) 2024-005512

(51) Int. Cl. B27N 7/00; B41J 2/21; B41J 3/28; B41J 3/407; B41J 3/44; B41M 5/00

(52) U.S. Cl. CPC B27N 7/005; B41J 2/2117; B41J 3/28; B41J 3/407; B41J 3/44; B41M 5/0017; B41M 5/0047; B41M 5/0076

(57) ABSTRACT

Provided are a fiberboard structure manufacturing method, a fiberboard structure manufacturing system, and a fiberboard structure, in which preferred inkjet type printing on a substrate to which a fiberboard is applied is implemented. A fiberboard structure manufacturing method includes: applying an aqueous sealer to a first surface of a substrate in which a fiberboard is used; forming an undercoat layer in which the aqueous sealer is dried, on the first surface; applying an aqueous preconditioning liquid having a function of thickening an aqueous ink to the first surface on which the undercoat layer is formed; and jetting the aqueous ink from an inkjet type jetting head to apply the aqueous ink to the first surface on which the aqueous preconditioning liquid is applied.

### CROSS-REFERENCE TO RELATED APPLICATION

The present application claims priority under 35 U.S.C § 119(a) to Japanese Patent Application No. 2024-005512 filed on Jan. 17, 2024, which is hereby expressly incorporated by reference, in its entirety, into the present application.

### BACKGROUND OF THE INVENTION

### 1. Field of the Invention

The present invention relates to a fiberboard structure manufacturing method, a fiberboard structure manufacturing system, and a fiberboard structure.

### 2. Description of the Related Art

In recent years, various types of materials have been used for a substrate in an inkjet type printing device. Examples of the material of the substrate include a wooden fiberboard such as an MDF. MDF is an abbreviation for medium density fiberboard.

In a case in which printing is performed by applying an inkjet method to the fiberboard such as the MDF, the fiberboard strongly absorbs an ink, and the ink does not remain on a surface of the fiberboard. In this case, there is a problem such as deterioration of color development as compared with a case in which printing is performed on a substrate such as paper. A method of preventing the ink from being absorbed into the fiberboard is disclosed in JP6991724B, WO2019/116536A, and JP6236471B, which are described below.

JP6991724B describes an inkjet recording device that switches an ink to be used, in accordance with a type of a recording medium on which recording is performed. The device described in JP6991724B performs recording using a clear emulsion ink and a reaction liquid in addition to a pigment-based ink in a case of performing recording on a low-permeability recording medium for outdoor exhibition.

WO2019/116536A describes a printing method in which an aqueous coating liquid is landed on a substrate, and an aqueous colored ink is landed on the coating liquid to form a printing layer. In WO2019/116536A, wood or the like is described as the substrate applied to the printing method.

JP6236471B describes an inkjet recording method for building material printing. The method described in JP6236471B includes a pretreatment step of forming a primer layer on a printing surface of the building material in advance. The primer layer suppresses the permeation of the ink into the building material and improves the adhesiveness of the ink.

### SUMMARY OF THE INVENTION

However, in the methods described in JP6991724B, WO2019/116536A, and JP6236471B, there is a problem in that the fiberboard absorbs the reaction liquid and the like described in JP6991724B, and it is difficult to leave the ink on an ink application surface of the fiberboard.

The present invention has been made in view of such circumstances, and an object of the present invention is to provide a fiberboard structure manufacturing method, a fiberboard structure manufacturing system, and a fiberboard structure, in which preferred inkjet type printing on a substrate to which a fiberboard is applied is implemented.

A first aspect of the present disclosure relates to a fiberboard structure manufacturing method comprising: forming an undercoat layer in which an aqueous sealer applied to a first surface of a substrate in which a fiberboard is used is dried, on the first surface; applying an aqueous preconditioning liquid having a function of thickening an aqueous ink to the first surface on which the undercoat layer is formed; and jetting the aqueous ink from an inkjet type jetting head to apply the aqueous ink to the first surface on which the aqueous preconditioning liquid is applied.

With the fiberboard structure manufacturing method according to the first aspect of the present disclosure, the preconditioning liquid is applied to the first surface of the substrate on which the aqueous sealer is applied. As a result, the permeation of the preconditioning liquid into the substrate is suppressed, and a specified amount of the preconditioning liquid remains on the first surface of the substrate.

In addition, liquid droplets of the aqueous ink are applied to the first surface of the substrate on which the preconditioning liquid remains. As a result, the liquid droplets of the ink landed on the preconditioning liquid are thickened, and the movement of the liquid droplets of the aqueous ink landed on the first surface of the substrate is suppressed.

A second aspect relates to the fiberboard structure manufacturing method according to the first aspect, in which the aqueous sealer and the aqueous ink may contain the same type of resin.

According to this aspect, the adhesiveness between the undercoat layer in which the aqueous sealer is dried and the aqueous ink can be relatively improved.

A third aspect relates to the fiberboard structure manufacturing method according to the first or second aspect, in which the aqueous sealer may be applied to be thicker than the aqueous ink.

According to this aspect, the permeation of the aqueous ink into the substrate is suppressed.

A fourth aspect relates to the fiberboard structure manufacturing method according to any one of the first to third aspects, in which the aqueous sealer may contain white coloring material particles.

According to this aspect, even in a case in which the first surface of the substrate has a color other than white, a white base is generated on the first surface of the substrate without using the white ink.

A fifth aspect relates to the fiberboard structure manufacturing method according to any one of the first to fourth aspects, in which the aqueous ink may include a white ink containing white coloring material particles, and in the application of the aqueous ink, the white ink may be applied to the first surface on which the aqueous preconditioning liquid is applied.

According to this aspect, even in a case in which the first surface of the substrate has a color other than white, the white base is generated on the first surface of the substrate.

A sixth aspect relates to the fiberboard structure manufacturing method according to any one of the first to fifth aspects, in which a coating liquid may be applied to the first surface on which the aqueous ink is applied.

According to this aspect, the rub resistance of the image printed by using the aqueous ink can be relatively improved.

The coating liquid applied to the first surface of the substrate may be dried.

A seventh aspect relates to the fiberboard structure manufacturing method according to the sixth aspect, in which in the application of the coating liquid, a non-contact process may be applied.

According to this aspect, the contact with the aqueous ink is avoided in a case in which the coating liquid is applied to the first surface of the substrate.

An eighth aspect relates to the fiberboard structure manufacturing method according to any one of the first to seventh aspects, in which a moisture proof layer may be formed on a second surface of the substrate opposite to the first surface.

According to this aspect, the permeation of moisture from the second surface into the substrate is suppressed, and the deterioration of the substrate due to the permeation of moisture can be suppressed.

A ninth aspect relates to the fiberboard structure manufacturing method according to any one of the first to eighth aspects, in which the first surface of the substrate may be subjected to a sanding treatment.

According to this aspect, the aqueous sealer can be uniformly applied to the first surface of the substrate.

A tenth aspect relates to the fiberboard structure manufacturing method according to any one of the first to ninth aspects, in which the undercoat layer may be formed on the first surface of the substrate by drying the aqueous sealer applied to the first surface of the substrate.

According to this aspect, the undercoat layer can be formed from the aqueous sealer.

An eleventh aspect relates to the fiberboard structure manufacturing method according to any one of the first to tenth aspects, in which the undercoat layer formed on the first surface of the substrate may be subjected to a sanding treatment.

According to this aspect, the preconditioning liquid and the aqueous ink can be uniformly applied to the undercoat layer.

A twelfth aspect of the present disclosure relates to a fiberboard structure manufacturing system comprising: a sealer application device that applies an aqueous sealer to a first surface of a substrate to which a fiberboard is applied; a preconditioning liquid application device that applies an aqueous preconditioning liquid having a function of thickening an aqueous ink to the first surface on which an undercoat layer in which the aqueous sealer is dried is formed; and an inkjet type jetting head that jets the aqueous ink to apply the aqueous ink to the first surface on which the aqueous preconditioning liquid is applied.

With the fiberboard structure manufacturing system according to the twelfth aspect of the present disclosure, it is possible to obtain the same effects as the effects of the fiberboard structure manufacturing method according to the first aspect of the present disclosure. The configuration requirements of the fiberboard structure manufacturing method according to the second aspect to the eleventh aspect can be applied to the configuration requirements of the fiberboard structure manufacturing system according to other aspects.

A thirteenth aspect of the present disclosure relates to a fiberboard structure comprising: a substrate to which a fiberboard is applied; an undercoat layer in which an aqueous sealer applied to a first surface of the substrate is dried; and an ink layer an ink layer in which an aqueous ink applied to an aqueous preconditioning liquid, which is applied to the undercoat layer and has a function of thickening the aqueous ink, is thickened by reacting with the aqueous preconditioning liquid.

With the fiberboard structure according to the thirteenth aspect of the present disclosure, it is possible to obtain the same effects as the effects of the fiberboard structure manufacturing method according to the first aspect of the present disclosure. The configuration requirements of the fiberboard structure manufacturing method according to the second aspect to the eleventh aspect can be applied to the configuration requirements of the fiberboard structure according to other aspects.

According to the aspects of the present invention, the preconditioning liquid is applied to the first surface of the substrate on which the aqueous sealer is applied. As a result, the permeation of the preconditioning liquid into the substrate is suppressed, and a specified amount of the preconditioning liquid remains on the first surface of the substrate.

In addition, liquid droplets of the aqueous ink are applied to the first surface of the substrate on which the preconditioning liquid remains. As a result, the liquid droplets of the ink landed on the preconditioning liquid are thickened, and the movement of the liquid droplets of the aqueous ink landed on the first surface of the substrate is suppressed.

### BRIEF DESCRIPTION OF THE DRAWINGS

FIG. 1 is a flowchart showing a procedure of a fiberboard structure manufacturing method according to an embodiment.

FIG. 2 is a block diagram showing a configuration example of a fiberboard structure manufacturing system according to the embodiment.

FIG. 3 is a functional block diagram showing an electric configuration of the fiberboard structure manufacturing system shown in FIG. 2.

FIG. 4 is a block diagram showing a hardware configuration of the electric configuration of the fiberboard structure manufacturing system shown in FIG. 2.

FIG. 5 is a schematic diagram showing a surface state of a substrate on which a sanding treatment is performed.

FIG. 6 is a schematic diagram showing the surface state of the substrate on which the sanding treatment is performed.

FIG. 7 is a schematic diagram showing the surface state of the substrate on which the sanding treatment is performed.

FIG. 8 is a configuration diagram of an inkjet printing device shown in FIG. 2 and the like.

FIG. 9 is a configuration diagram showing a printing state of the inkjet printing device shown in FIG. 8.

FIG. 10 is a cross-sectional view showing a structure example of a fiberboard structure.

### DESCRIPTION OF THE PREFERRED EMBODIMENTS

Hereinafter, a detailed description of a preferred embodiment of the present invention will be made with reference to the accompanying drawings. In the present specification, the same constituent elements are denoted by the same reference numerals and the duplicate description thereof will be omitted as appropriate. In the following embodiment, in a case in which a plurality of constituent elements are described and listed, it can be interpreted that at least one of the plurality of constituent elements is included.

### Fiberboard Structure Manufacturing Method

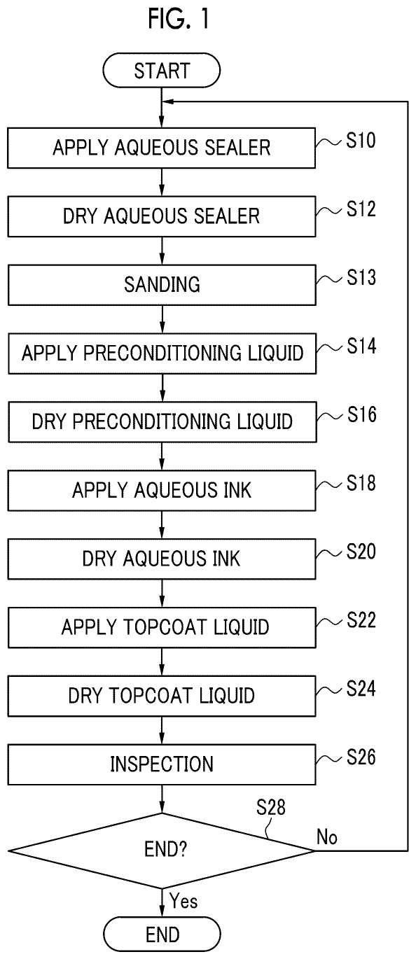

FIG. 1 is a flowchart showing a procedure of a fiberboard structure manufacturing method according to the embodiment. Hereinafter, as a substrate of a fiberboard structure, a wooden fiberboard such as a medium density fiberboard is described. The medium density fiberboard is manufactured by using compressed wooden fibers as materials with an adhesive. Since the medium density fiberboard is manufactured by using waste materials, leftover materials, and the like as materials, the medium density fiberboard has relatively high environmental suitability.

In the following embodiment, the fiberboard is described as the substrate of the fiberboard structure, but the material of the fiberboard is not limited to wood, and a natural fiber collected from a plant, an animal, or a mineral may be used, or an artificial fiber produced by artificial production, such as a chemical fiber, may be used.

The chemical fiber may be an inorganic fiber or an organic fiber. Examples of the inorganic fiber include a metal fiber, a glass fiber, a carbon fiber, and a rock fiber. Examples of the organic fiber include synthetic fibers such as nylon, vinylon, and keppra, semi-synthetic fibers, and regenerated fibers such as rayon and PET. It should be noted that PET is an abbreviation for polyethylene terephthalate.

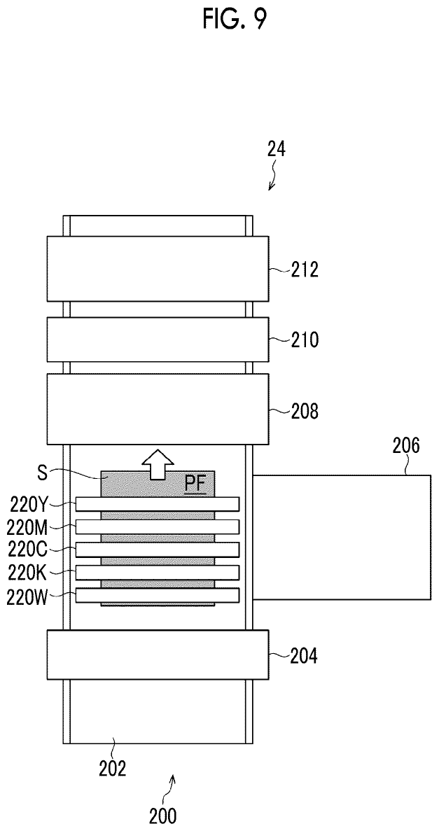

In an aqueous sealer application step S10 shown in FIG. 1, a sealer application device is used, and an aqueous sealer is applied to a printing surface of the substrate to which the wooden fiberboard is applied. The printing surface of the substrate may be one surface of the substrate or the other surface of the substrate. That is, the printing surface of the substrate may be at least one of one surface or the other surface of the substrate. It should be noted that the substrate to which the wooden fiberboard is applied is shown in FIG. 9 and the like by being denoted by a reference numeral S. The printing surface of the substrate is denoted by a reference numeral PF and is shown in FIG. 9 and the like.

In the substrate to which the wooden fiberboard is applied, a sanding treatment may be performed on the printing surface before the aqueous sealer application step S10 is executed, and at least a part of the fluff on the printing surface may be removed. A sanding machine may be applied to the sanding treatment on the printing surface, or the sanding treatment may be manually performed.

The substrate of which the printing surface is subjected to the sanding treatment may be subjected to a removal treatment of dust or the like on the printing surface. A method such as suction, air blowing, or wiping may be applied to the removal treatment of dust or the like on the printing surface.

The aqueous sealer is applied to an entire surface of the printing surface of the substrate. The aqueous sealer functions as an undercoat layer on the printing surface of the substrate. The aqueous sealer may contain resin particles such as acrylic resin and urethane resin.

Pigment particles, such as titanium oxide, which function as white coloring material particles may be dispersed in the aqueous sealer. As a result, a white base can be formed on the printing surface of the substrate.

As an application amount of the aqueous sealer in a liquid state before a drying treatment, a mass per unit area may be applied. For example, the application amount of the aqueous sealer in a liquid state before the drying treatment may be 0.1 grams per square meter or more and 1,000 grams per square meter or less. The application amount of the aqueous sealer in a liquid state before the drying treatment is preferably 10 grams per square meter or more, and more preferably 100 grams per square meter or more. It should be noted that grams per square meter can be referred to as gsm as an abbreviation.

Examples of the aqueous sealer include an aqueous sanding sealer manufactured by Asahipen Corporation., an aqueous sanding sealer manufactured by WASHIN PAINT CO., LTD., and an aqueous undercoat sealer for wooden parts manufactured by NIPPONPAINT.

The aqueous sealer is a material called a wood sealer, a grinding powder, a surfacer, and the like, in addition to the above-described sanding sealer and the like, and can include all materials used for the treatment on the substrate before the main coating is performed. The aqueous sealer may dissolve or disperse a solutes using the above-described material in a solvent containing water as a main component.

The aqueous sealer application step S10 may include an application condition setting step. The application condition setting step may be executed before the execution of the aqueous sealer application step S10. The application conditions of the aqueous sealer may include a type of the substrate, a type of the aqueous sealer, the application amount of the aqueous sealer, and the like. After the aqueous sealer application step S10, the process proceeds to an aqueous sealer drying step S12.

In the aqueous sealer drying step S12, a sealer drying device is used to perform the drying treatment on the aqueous sealer applied to the printing surface of the substrate. In the aqueous sealer drying step S12, an aspect may be applied in which the substrate on which the aqueous sealer is applied is stored in a room temperature environment. As the room temperature, a temperature of 20° C. or higher and 25° C. or lower may be applied. In addition, a treatment time may be 1 hour or more. An upper limit of the treatment time may be specified from the viewpoint of productivity.

In the aqueous sealer drying step S12, the substrate on which the aqueous sealer is applied is stored in a high temperature environment as compared with the room temperature environment, and the productivity may be relatively improved. As the high temperature, a temperature of 25° C. or higher such as 50° C. may be applied. An upper limit temperature of the high temperature may be specified in accordance with the durability of the substrate. In the aqueous sealer drying step S12, air blowing may be applied, and heating and air blowing may be combined as appropriate.

The aqueous sealer drying step S12 may include a drying condition setting step. The drying condition setting step may be executed before the aqueous sealer drying step S12 is executed. The drying conditions of the aqueous sealer may include a treatment temperature, a treatment time, and the like. After the aqueous sealer drying step S12, the process proceeds to a sanding step S13.

In the sanding step S13, a sanding device is used to perform the sanding treatment on the undercoat layer which is the dried aqueous sealer. The sanding treatment on the undercoat layer can remove the fluffing on the printing surface of the substrate, which is generated by the permeation of the aqueous sealer into the substrate. The sanding treatment on the undercoat layer smoothens the undercoat layer.

The aqueous sealer application step S10, the aqueous sealer drying step S12, and the sanding step S13 may be repeatedly executed two or more times. In particular, in a case in which the glossiness of the printing surface of the substrate is desired to be relatively increased, the application, the drying, and the sanding of the aqueous sealer may be repeatedly executed a plurality of times.

The smoothness of the printing surface of the substrate may be measured after the sanding treatment is performed on the undercoat layer. The application, the drying, and the sanding of the aqueous sealer may be repeatedly executed a plurality of times until specified smoothness is satisfied. A surface roughness may be applied as an indicator of smoothness.

The aqueous sealer application step S10, the aqueous sealer drying step S12, and the sanding step S13 shown in FIG. 1 are understood as steps included in a preparation method for the substrate. After the substrate is subjected to the preparation, the process proceeds to a preconditioning liquid application step S14.

In the preconditioning liquid application step S14, a preconditioning liquid application device is used, and the aqueous preconditioning liquid is applied to the printing surface of the substrate on which the undercoat layer in which the aqueous sealer is dried is formed.

As the aqueous preconditioning liquid, an acidic liquid having a function of reacting with the aqueous ink to thicken the aqueous ink may be applied. The aqueous preconditioning liquid of a strong acid may decompose polymer substances, such as cellulose and lignin constituting the substrate. Therefore, the aqueous preconditioning liquid applied to the printing surface of the substrate is preferably a weak acid rather than a strong acid. The aqueous preconditioning liquid can be referred to as a treatment liquid, a pretreatment liquid, a reaction liquid, and the like.

A pH of the aqueous preconditioning liquid is preferably 2 or more, and more preferably 3 or more. The aqueous preconditioning liquid is preferably neutral with a pH of about 7. The aqueous preconditioning liquid may contain resin particles such as acrylic resin and urethane resin. In the aqueous preconditioning liquid, the pigment particles, such as titanium oxide, which function as white coloring material particles may be dispersed. In a case in which the white base is formed on the printing surface of the substrate, the aqueous sealer is effective in a case in which a preferred white base is not implemented only by the undercoat layer in which the aqueous sealer is dried.

In a case in which the inkjet type printing is performed on the printing surface of the substrate by using the aqueous ink, the aqueous sealer and the aqueous preconditioning liquid may be used. As a result, the adhesiveness of the aqueous ink to the substrate can be relatively improved.

Roll coater coating may be applied to the preconditioning liquid application device. In the roll coater coating, the aqueous preconditioning liquid is supplied to a rubber roll, the aqueous preconditioning liquid is transferred to the printing surface of the substrate, and a coating film of the aqueous preconditioning liquid is formed. The roll coater coating is suitable for forming the coating film of a building material panel or the like having a constant thickness.

An inkjet type coating may be applied to the preconditioning liquid application device. In a case of the inkjet type, the preconditioning liquid can be applied only to a place in which the color ink needs to be applied, and the consumption amount of the preconditioning liquid can be suppressed as compared with a case in which the preconditioning liquid is applied to the entire surface of the printing surface.

The application amount of the aqueous preconditioning liquid in a liquid state before the drying treatment may be 0.1 grams per square meter or more and 10 grams per square meter or less. The application amount of the aqueous preconditioning liquid may be 1.0 gram per square meter.

The application amount of the aqueous preconditioning liquid in a liquid state before the drying treatment may be less than the application amount of the aqueous sealer in a liquid state before the drying treatment. For example, in a case in which the application amount of the aqueous sealer in a liquid state before the drying treatment is 100 grams per square meter, the application amount of the aqueous preconditioning liquid in a liquid state before the drying treatment may be set to 1.0 grams per square meter. After the preconditioning liquid application step S14, the process proceeds to a preconditioning liquid drying step S16.

In the preconditioning liquid drying step S16, a preconditioning liquid drying device is used, and the aqueous preconditioning liquid applied to the printing surface of the substrate is subjected to the drying treatment. In the drying treatment, the heating may be applied, or the air blowing may be applied. In the drying treatment, the heating and the air blowing may be combined as appropriate.

In the preconditioning liquid drying step S16, a specified treatment temperature and a specified treatment time are applied, and the aqueous preconditioning liquid applied to the printing surface of the substrate is dried. The preconditioning liquid drying step S16 may include the drying condition setting step. The drying condition setting step may be executed before the preconditioning liquid drying step S16 is executed. The drying conditions may include the treatment temperature, the treatment time, and the like. After the preconditioning liquid drying step S16, an aqueous ink application step S18 is executed.

In the aqueous ink application step S18, the inkjet printing device is used, the aqueous ink is applied to the dried aqueous preconditioning liquid on the printing surface of the substrate, and an image based on image data is printed. The image may include characters, symbols, figures, patterns, or the like. The image data may be raster data or may be data in a PDF format.

The aqueous ink is an ink in which the solutes such as pigment particles and the resin particles are dissolved or dispersed in the solvent containing water as a main component. An aspect is preferable in which the aqueous ink used in the inkjet printing device contains latex. In a printed image in which the aqueous ink containing latex is used, the rub resistance of the surface is relatively improved, and the manufacturing stability in a case in which a topcoat liquid is applied to the ink after the drying treatment can be relatively improved.

In addition, the printed image in which the aqueous ink containing latex is used can be used as a printed material without being coated with the topcoat liquid. Here, the term “printed material” refers to the substrate in which the image is printed on the printing surface.

The resin particles contained in the aqueous ink may be the same type as the resin particles contained in the aqueous sealer. In a case in which the same type of resin particles are contained in the aqueous ink and the aqueous sealer, the adhesiveness of the aqueous ink to the undercoat layer can be improved as compared with a case in which different types of resin particles are contained.

The aqueous ink may be a functional ink in which particles of an inorganic material such as a metal and particles of an organic material are dispersed or dissolved in the solvent containing water as a main component. In a liquid state, the functional ink does not exhibit specified performance such as conductivity, but the specified performance may be exhibited due to the treatment such as the drying. After the aqueous ink application step S18, the process proceeds to an aqueous ink drying step S20.

The application amount of the aqueous ink in a liquid state before the drying treatment may exceed the application amount of the aqueous preconditioning liquid in a liquid state before the drying treatment. In a case in which the application amount of the aqueous preconditioning liquid in a liquid state before the drying treatment is 1.0 gram per square meter, the application amount of the aqueous ink in a liquid state before the drying treatment may be 10 grams per square meter.

In the aqueous ink drying step S20, an ink drying device is used, a specified treatment temperature and a specified treatment time are applied, and the drying treatment is performed on the printed image printed on the printing surface of the substrate.

The aqueous ink drying step S20 may include the drying condition setting step. The drying condition setting step may be executed before the aqueous ink drying step S20 is executed. The drying conditions may include the treatment temperature, the treatment time, and the like. After the aqueous ink drying step S20, a topcoat liquid application step S22 is executed.

In the topcoat liquid application step S22, a topcoat liquid application device is used, and the topcoat liquid is applied to the entire surface of the printing surface of the substrate on which the image of the aqueous ink is printed and the drying treatment is performed. As the topcoat liquid, varnish, lacquer, and the like may be applied.

A method such as a roll coater and a curtain flow is applied to the topcoat liquid application device. The aqueous ink has a slower drying v than a solvent-based ink, an ultraviolet curable ink, and the like, and the surface rub resistance of the printed image immediately after the drying treatment may be relatively low, and the surface rub resistance may be insufficient. In this case, from the viewpoint of protecting the surface of the printed image, a non-contact curtain flow method may be preferably used instead of the contact roll coater method.

An electrostatic spray method, an electrodeposition method, a powder spray method, or an immersion method may be applied to the topcoat liquid application device. After the topcoat liquid application step S22, a topcoat liquid drying step S24 is executed.

In the topcoat liquid drying step S24, a topcoat liquid drying device is used to perform the drying treatment on the topcoat liquid applied to the printed image of the aqueous ink. In the drying treatment, the heating, the air blowing, and the like can be applied. In the drying treatment, the heating and the air blowing may be combined as appropriate.

The topcoat liquid drying step S24 may include the drying condition setting step. The drying condition setting step may be executed before the topcoat liquid drying step S24 is executed. The drying conditions may include the treatment temperature, the treatment time, and the like.

The topcoat layer formed on the surface of the printed image may be formed by applying lamination processing of a resin sheet via a laminating machine. After the topcoat liquid drying step S24, an inspection step S26 is executed.

In the inspection step S26, an inspection device is used, and whether or not there is a defect in the printed image is determined. Examples of the defect of the printed image include missing dots, streaks, density unevenness, and color shift. The inspection step S26 may include an imaging step of imaging the printed image using an image sensor or the like, a defect detection step of detecting the defect of the printed image from the imaging data of the printed image, and an inspection result notification step of notifying of an inspection result of the printed image.

In a case in which each step from the aqueous sealer application step S10 to the inspection step S26 is executed on one substrate and it is determined in the inspection step S26 that the substrate is a good product having no defect, one fiberboard structure is completed. In a case in which a specified number of fiberboard structures are manufactured, each step from the aqueous sealer application step S10 to the inspection step S26 is executed for each of a specified number of substrates. After the inspection step S26, an end determination step S28 is executed.

In the end determination step S28, a computer functioning as a control device determines whether or not a specified end condition is satisfied. Examples of the end condition include end of the manufacturing of the specified number of fiberboard structures, change of the image data, and change of the substrate.

In the end determination step S28, in a case in which the computer determines that the specified end condition is not satisfied, the determination result is No. In a case in which the determination result is No, each step from the aqueous sealer application step S10 to the end determination step S28 is repeatedly executed until the determination result is Yes in the end determination step S28.

On the other hand, in the end determination step S28, in a case in which the computer determines that the specified end condition is satisfied, the determination result is Yes. In a case of the determination result is Yes, a specified end process is executed, and the procedure of the fiberboard structure manufacturing method ends.

### Configuration Example of Fiberboard Structure Manufacturing System

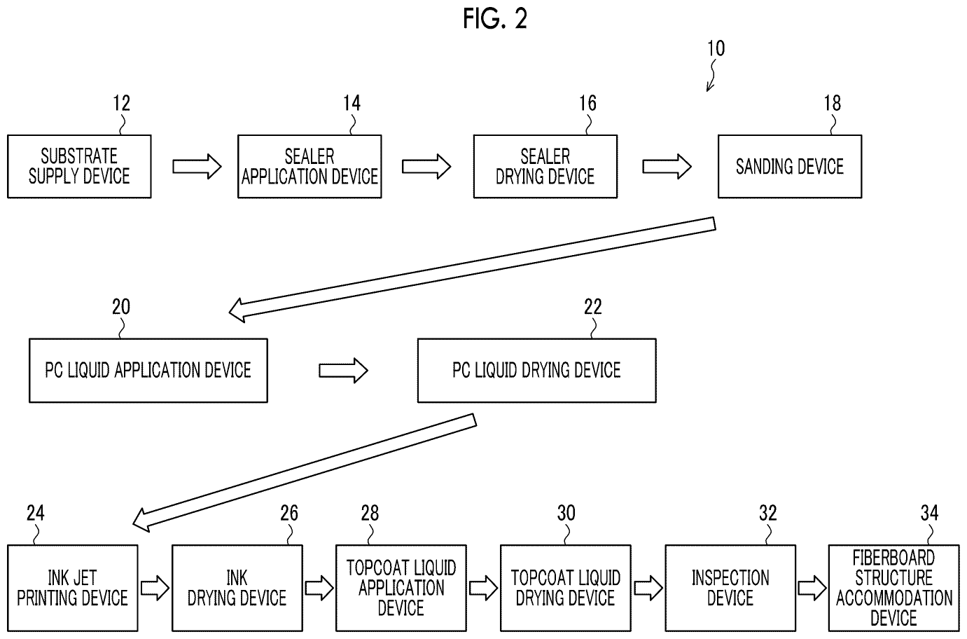

FIG. 2 is a block diagram showing a configuration example of a fiberboard structure manufacturing system according to the embodiment. An arrow line shown in FIG. 2 represents the movement of the substrate. A transport device that transports the substrate is applied to the movement of the substrate.

The fiberboard structure manufacturing system 10 comprises a substrate supply device 12. The substrate supply device 12 comprises a substrate accommodation section in which the substrate to be printed is accommodated, a substrate take-out section that takes out the substrate one by one, and a substrate carry-out section that carries out the substrate. The substrate supply device 12 supplies the substrate one by one to a device in the rear stage at a specified timing.

The fiberboard structure manufacturing system 10 may comprise a sanding pretreatment device that performs the sanding treatment on the substrate carried out from the substrate supply device 12. The sanding pretreatment device may carry out the substrate on which the sanding treatment is performed.

The fiberboard structure manufacturing system 10 comprises a sealer application device 14, a sealer drying device 16, and a sanding device 18. The sealer application device 14 receives the substrate carried out from the substrate supply device 12, and executes the aqueous sealer application step S10 shown in FIG. 1 to apply the aqueous sealer to the printing surface of the substrate.

The sealer drying device 16 receives the substrate on which the aqueous sealer is applied, and executes the aqueous sealer drying step S12 to perform the drying treatment on the printing surface of the substrate on which the aqueous sealer is applied. The sealer drying device 16 carries out the substrate in which the undercoat layer in which the aqueous sealer is dried is formed on the printing surface.

The sanding device 18 receives the substrate carried out from the sealer drying device 16, performs the sanding treatment on the undercoat layer formed on the printing surface of the substrate, and smooths the undercoat layer. The sanding device 18 carries out the substrate in which the undercoat layer is smoothed.

The fiberboard structure manufacturing system 10 comprises a preconditioning liquid application device 20 and a preconditioning liquid drying device 22. The preconditioning liquid application device 20 receives the substrate on which the undercoat layer, which is carried out from the sanding device 18, is smoothed and executes the preconditioning liquid application step S14 to apply the preconditioning liquid to the undercoat layer of the printing surface of the substrate. The preconditioning liquid application device 20 carries out the substrate on which the preconditioning liquid is applied.

The preconditioning liquid drying device 22 receives the substrate on which the preconditioning liquid is applied, and executes the preconditioning liquid drying step S16 to perform the drying treatment on the printing surface of the substrate on which the preconditioning liquid is applied.

The preconditioning liquid drying device 22 may adjust the temperature of the printing surface of the substrate based on the temperature suitable for the inkjet type printing. The preconditioning liquid drying device 22 carries out the substrate on which a layer in which the preconditioning liquid is dried is formed.

The fiberboard structure manufacturing system 10 comprises an inkjet printing device 24 and an ink drying device 26. The inkjet printing device 24 receives the substrate on which the layer in which the preconditioning liquid is dried is formed, and executes the aqueous ink application step S18 to print the image based on the image data on the printing surface of the substrate. The inkjet printing device 24 carries out the substrate in which the image is printed on the printing surface.

The ink drying device 26 receives the substrate in which the image is printed on the printing surface, and executes the aqueous ink drying step S20 to fix the image on the printing surface of the substrate. The ink drying device 26 carries out the substrate in which the image is fixed to the printing surface.

The fiberboard structure manufacturing system 10 comprises a topcoat liquid application device 28 and a topcoat liquid drying device 30. The topcoat liquid application device 28 receives the substrate carried out from the ink drying device 26, and executes the topcoat liquid application step S22 to apply the topcoat liquid to the entire surface of the printing surface of the substrate. The topcoat liquid application device 28 carries out the substrate on which the topcoat liquid is applied.

The topcoat liquid drying device 30 receives the substrate carried out from the topcoat liquid application device 28, and executes the topcoat liquid drying step S24 to dry the topcoat liquid applied to the entire surface of the printing surface of the substrate. The topcoat liquid drying device 30 carries out the fiberboard structure that is the substrate in which the topcoat liquid on the printing surface on which the image is printed is dried.

The fiberboard structure manufacturing system 10 may comprise a laminating machine that laminates the resin sheet on the printing surface of the substrate on which the image is printed, instead of the topcoat liquid application device 28 and the topcoat liquid drying device 30.

The fiberboard structure manufacturing system 10 comprises an inspection device 32. The inspection device 32 receives the fiberboard structure carried out from the topcoat liquid drying device 30, and executes the inspection step S26 to determine whether or not there is the defect in the image printed on the printing surface of the substrate. That is, the inspection device 32 determines a quality of the fiberboard structure.

The inspection device 32 notifies of the inspection result. As the notification of the inspection result, character information indicating the inspection result may be displayed on the display or sound information indicating the inspection result may be output from the speaker. The inspection device 32 carries out the inspected fiberboard structure. The inspection device 32 may distinguish between a good product and a defective product to carry out the inspected fiberboard structure.

The inspection device 32 may receive the substrate before the topcoat layer is formed, which is carried out from the ink drying device 26, and execute the inspection step S26 to determine whether or not there is the defect in the printed image on the substrate before the topcoat layer is formed.

The fiberboard structure manufacturing system 10 comprises a fiberboard structure accommodation device 34. The fiberboard structure accommodation device 34 receives the fiberboard structure carried out from the inspection device 32 and accommodates the fiberboard structure. The fiberboard structure accommodation device 34 may distinguish and accommodate the good product and the defective product of the fiberboard structure.

### Electric Configuration of Fiberboard Structure Manufacturing System

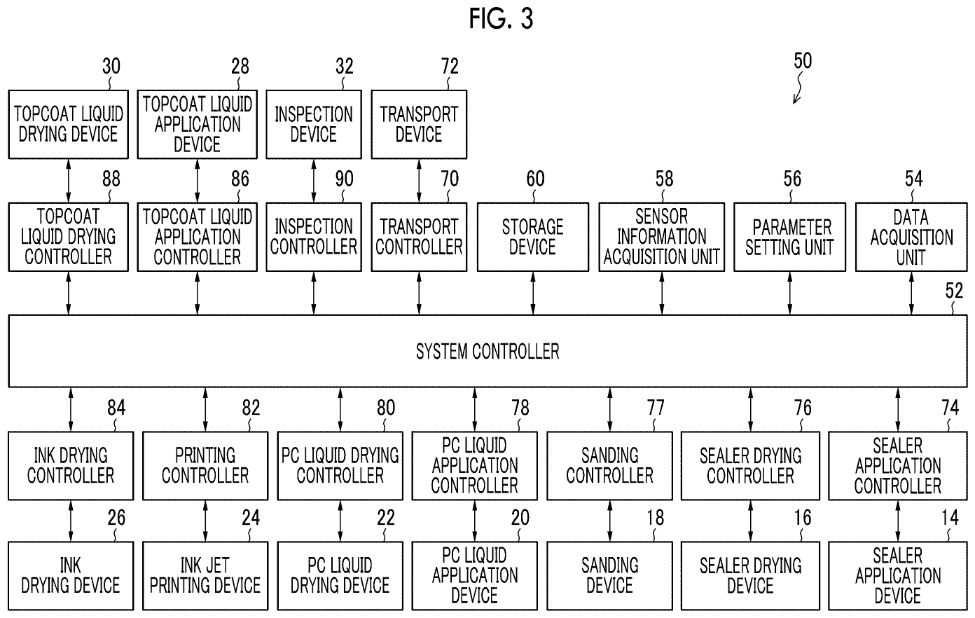

FIG. 3 is a functional block diagram showing an electric configuration of the fiberboard structure manufacturing system shown in FIG. 2. The fiberboard structure manufacturing system 10 shown in FIG. 2 comprises a control device 50.

The control device 50 is configured by a computer. The computer applied to the control device 50 may be a personal computer, may be a workstation, or may be a server computer.

It should be noted that the processing function of the control device 50 may be implemented as a computer system including a plurality of computers. The computer applied to the control device 50 may be a virtual machine.

The control device 50 comprises a storage device 60. Various types of data, parameters, and the like used by the control device 50 are stored in the storage device 60. The storage device 60 stores various programs executed by the control device 50. The storage device 60 may be configured as an external device of the control device 50. The storage device 60 may be configured as a combination of the external device of the control device 50 and an internal device of the control device 50.

The control device 50 comprises a system controller 52. The system controller 52 integrally controls various processing units constituting the control device 50. The system controller 52 functions as a memory driver that controls writing of data to the storage device 60 and reading of data from the storage device 60.

The control device 50 comprises a data acquisition unit 54 and a parameter setting unit 56. The data acquisition unit 54 acquires various types of data such as printing data transmitted from the external device. The data acquisition unit 54 stores the acquired various types of data in a specified storage device. As the specified storage device, the storage device 60 may be applied. The parameter setting unit 56 sets various parameters.

The control device 50 comprises a sensor information acquisition unit 58. The sensor information acquisition unit 58 acquires various types of sensor information transmitted from various sensors provided in the fiberboard structure manufacturing system 10. The various sensors may include a temperature sensor and a position detection sensor that detects a position of the substrate.

The control device 50 comprises a transport controller 70. The transport controller 70 controls the operation of the transport device 72 that transports the substrate, based on a command signal transmitted from the system controller 52. The transport controller 70 controls a transport start timing of the substrate, a stop timing of the substrate, a transport speed of the substrate, and the like.

The transport device 72 includes a device that transports the substrate in various devices shown in FIG. 2. The transport device 72 includes a device that transports the substrate between various devices shown in FIG. 2.

The transport device 72 may include the substrate supply device 12 and the fiberboard structure accommodation device 34 shown in FIG. 2. The substrate referred to herein includes a fiberboard structure in which a specified image is printed on the substrate.

The control device 50 comprises a sealer application controller 74. The sealer application controller 74 sets a sealer application condition in accordance with a command signal transmitted from the system controller 52, and controls the operation of the sealer application device 14.

The control device 50 comprises a sealer drying controller 76. The sealer drying controller 76 sets a sealer drying condition in accordance with a command signal transmitted from the system controller 52, and controls the operation of the sealer drying device 16.

The control device 50 comprises a sanding controller 77. The sanding controller 77 sets a sanding condition in accordance with a command signal transmitted from the system controller 52, and controls the operation of the sanding device 18.

The control device 50 comprises a preconditioning liquid application controller 78. The preconditioning liquid application controller 78 sets a preconditioning liquid application condition in accordance with a command signal transmitted from the system controller 52, and controls the operation of the preconditioning liquid application device 20.

The control device 50 comprises a preconditioning liquid drying controller 80. The preconditioning liquid drying controller 80 sets a preconditioning liquid drying condition in accordance with a command signal transmitted from the system controller 52, and controls the operation of the preconditioning liquid drying device 22.

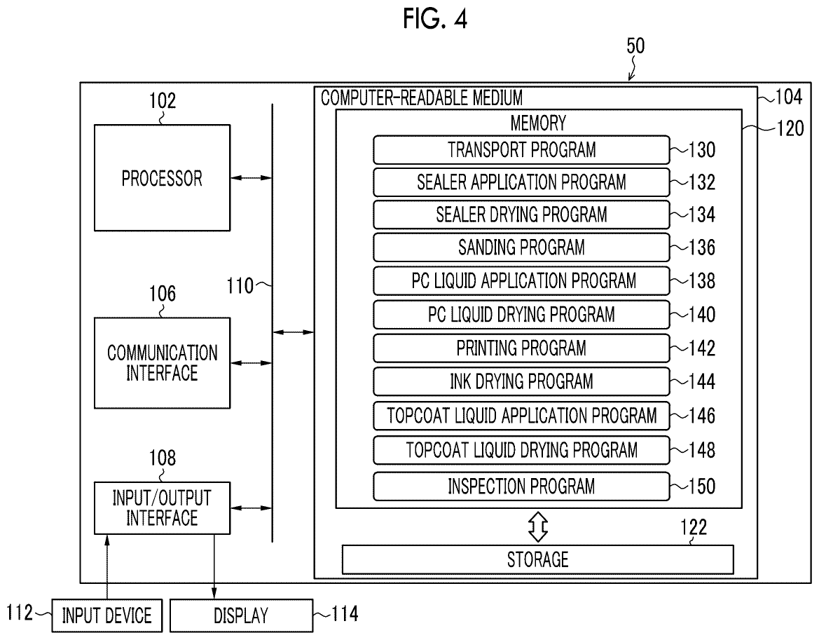

It should be noted that the PC liquid in FIG. 3 represents a preconditioning liquid. The same applies to the PC liquid in FIG. 4.

The control device 50 comprises a printing controller 82. The printing controller 82 sets a printing condition in accordance with a command signal transmitted from the system controller 52, and controls the operation of the inkjet printing device 24. That is, the printing controller 82 acquires the printing data via the data acquisition unit 54, performs image processing on the printing data, and generates a drive voltage and a drive signal to be supplied to the inkjet head.

The control device 50 comprises an ink drying controller 84. The ink drying controller 84 sets an ink drying condition in accordance with a command signal transmitted from the system controller 52, and controls the operation of the ink drying device 26.

The control device 50 comprises a topcoat liquid application controller 86. The topcoat liquid application controller 86 sets a topcoat liquid application condition in accordance with a command signal transmitted from the system controller 52, and controls the operation of the topcoat liquid application device 28.

The control device 50 comprises a topcoat liquid drying controller 88. The topcoat liquid drying controller 88 sets a topcoat liquid drying condition in accordance with a command signal transmitted from the system controller 52, and controls the operation of the topcoat liquid drying device 30.

The control device 50 comprises an inspection controller 90. The inspection controller 90 sets an inspection condition in accordance with a command signal transmitted from the system controller 52, and controls the operation of the inspection device 32. The inspection controller 90 transmits the inspection result to the system controller 52. The system controller 52 generates a signal indicating the inspection result and outputs a signal for notifying of the inspection result.

FIG. 4 is a block diagram showing a hardware configuration of the electric configuration of the fiberboard structure manufacturing system shown in FIG. 2. The computer comprising one or more processors and one or more memories in which a program including instructions executed by the one or more processors is stored is applied as the control device 50. The control device 50 may be configured by a plurality of computers.

The control device 50 shown in FIG. 4 comprises a processor 102, a computer-readable medium 104, a communication interface 106, an input/output interface 108, and a bus 110.

The processor 102 includes a CPU. The processor 102 may include a GPU. It should be noted that CPU is an abbreviation for central processing unit. GPU is an abbreviation for graphics processing unit.

The processor 102 is connected to the computer-readable medium 104, the communication interface 106, and the input/output interface 108 through the bus 110. The input device 112 and the display 114 are connected to the control device 50 through the input/output interface 108.

In the control device 50, the processor 102 executes the program stored in the computer-readable medium 104 to implement various functions. The term “program” is synonymous with the term “software”.

The computer-readable medium 104 comprises a memory 120 as a main storage device and a storage 122 as an auxiliary storage device. A semiconductor memory, a hard disk device, a solid-state drive device, and the like may be applied to the computer-readable medium 104. Any combination of a plurality of devices may be applied to the computer-readable medium 104.

The hard disk device can be referred to as HDD that is an abbreviation for hard disk drive. The solid-state drive device can be referred to as SSD that is an abbreviation for solid state drive.

The control device 50 performs data communication with an external device through the communication interface 106. Various standards, such as USB, can be applied to the communication interface 106. Either the wired communication or the wireless communication may be applied to a communication form of the communication interface 106. It should be noted that USB is an abbreviation for Universal Serial Bus, and is a registered trademark.

The input device 112 and the display 114 are connected to the processor 102 through the input/output interface 108. An input device such as a keyboard and a mouse is applied to the input device 112. Various types of information applied to the control device 50 are displayed on the display 114.

The display 114 is used as a part of a graphical user interface in a case of receiving the input from the input device 112. It should be noted that the display 114 is not limited to one, and a multi-display form comprising a plurality of displays can also be adopted.

A liquid crystal display, an organic EL display, a projector, or the like may be applied to the display 114. Any combination of a plurality of devices can be applied to the display 114. EL of the organic EL display is an abbreviation for electro-luminescence.

The memory 120 of the computer-readable medium 104 stores a transport program 130, a sealer application program 132, a sealer drying program 134, and a sanding program 136 that are executed by the processor 102.

The memory 120 stores a preconditioning liquid application program 138, a preconditioning liquid drying program 140, a printing program 142, and an ink drying program 144. The memory 120 stores a topcoat liquid application program 146, a topcoat liquid drying program 148, and an inspection program 150.

The transport program 130 is applied to the transport controller 70 shown in FIG. 3 to implement a substrate transport function. The sealer application program 132 is applied to the sealer application controller 74 to implement an aqueous sealer application function. The sealer drying program 134 is applied to the sealer drying controller 76 to implement an aqueous sealer drying function. The sanding program 136 is applied to the sanding controller 77 to implement a function of sanding on the dried aqueous sealer.

The preconditioning liquid application program 138 is applied to the preconditioning liquid application controller 78 to implement a preconditioning liquid application function. The preconditioning liquid drying program 140 is applied to the preconditioning liquid drying controller 80 to implement a preconditioning liquid drying function.

The printing program 142 is applied to the printing controller 82 to implement a printing function. The printing program 142 may include an image processing program that generates halftone data from the image data and a jetting control signal generation program that generates a jetting control signal for the inkjet head based on the halftone data.

The ink drying program 144 is applied to the ink drying controller 84 to implement an ink drying function. The topcoat liquid application program 146 is applied to the topcoat liquid application controller 86 to implement a topcoat liquid application function. The topcoat liquid drying program 148 is applied to the topcoat liquid drying controller 88 to implement a topcoat liquid drying function. The inspection program 150 is applied to the inspection controller 90 to implement an inspection function.

Various programs stored in the computer-readable medium 104 include one or more instructions. Various types of data, various parameters, and the like are stored in the computer-readable medium 104.

Here, examples of the hardware structure of the processor 102 include a CPU, a GPU, a programmable logic device (PLD), and an application-specific integrated circuit (ASIC). The CPU is a general-purpose processor that executes the program and that acts as various functional units. The GPU is a processor specialized for the image processing.

The PLD is a processor in which a configuration of an electric circuit is changeable after manufacturing the device. Examples of the PLD include a field programmable gate array (FPGA). The ASIC is a processor comprising a dedicated electric circuit specifically designed to execute specific processing.

One processing unit may be configured by one of these various processors or two or more processors of the same type or different types. Examples of the combination of the various processors include a combination of one or more FPGAs and one or more CPUs, and a combination of one or more FPGAs and one or more GPUs. Examples of the combination of the various processors also include a combination of one or more CPUs and one or more GPUs.

A plurality of functional units may be configured by one processor. As an example in which the plurality of functional units are configured by one processor, there is an aspect in which one processor is configured by applying a combination of one or more CPUs and software, such as system on a chip (SoC) represented by the computer, such as a client or a server, and this processor is made to act as the plurality of functional units.

As another example in which the plurality of functional units are configured by one processor, there is an aspect in which a processor that implements the functions of the entire system including the plurality of functional units by using one IC chip is used. It should be noted that IC is an abbreviation for integrated circuit.

As described above, various functional units are configured by one or more of the various processors described above as the hardware structure. Further, the hardware structure of these various processors is, more specifically, an electric circuit (circuitry) in which circuit elements, such as semiconductor elements, are combined.

### Modification Example of Control Device

Various processing units provided in the control device 50 shown in FIGS. 3 and 4 may be provided in various devices constituting the fiberboard structure manufacturing system 10 such as the sealer application device 14 shown in FIG. 2.

For example, the data acquisition unit 54, the parameter setting unit 56, the sensor information acquisition unit 58, and the storage device 60 shown in FIG. 3 may be provided in the sealer application device 14 and the like. That is, the sealer application device 14 and the like may each be provided with various control devices to which the computer is applied.

For example, the sealer application controller 74 may be provided in the sealer application device 14. The control device of the sealer application device 14 may acquire a command signal transmitted from the control device 50, and execute the sealer application program based on the command signal to control the operation of the sealer application device 14 and implement the aqueous sealer application function. The same applies to the sealer drying device 16, the preconditioning liquid application device 20, and the like.

### Specific Example of Sanding Treatment

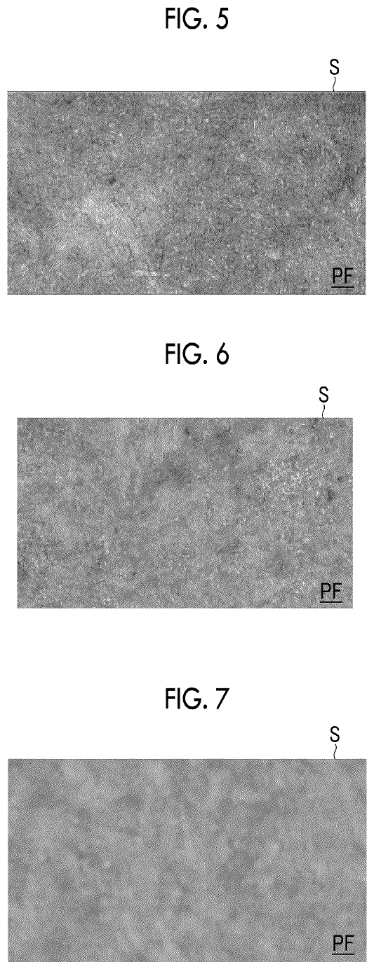

FIGS. 5 to 7 are schematic diagrams showing surface states of the substrate on which the sanding treatment is performed. FIG. 5 shows the printing surface PF of the substrate S in a case in which the undercoat layer generated by performing the application of the aqueous sealer once and the drying of the aqueous sealer once is lightly sanded by using sandpaper.

FIG. 6 shows the printing surface PF of the substrate S in a case in which the undercoat layer generated by performing the application of the aqueous sealer once and the drying of the aqueous sealer once is sanded by using sandpaper having a particle size of #400. FIG. 7 shows the printing surface PF of the substrate S in a case in which the application of the aqueous sealer, the drying of the aqueous sealer, and the sanding using #400 sandpaper are repeated twice.

The printing surface PF of the substrate S shown in FIG. 6 has more improved smoothness and smoother than the printing surface PF of the substrate S shown in FIG. 5. The printing surface PF of the substrate S shown in FIG. 7 has more improved smoothness and smoother than the printing surface PF of the substrate S shown in FIG. 6.

In the sanding on the undercoat layer generated by applying the aqueous sealer to the printing surface PF of the substrate S and drying the aqueous sealer, the roughness of the grain of the file, the pressing force of the file against the substrate S, and the number of times of sanding may be specified in accordance with the type of the substrate S, the type of the aqueous sealer, the type of the preconditioning liquid, and the like. It should be noted that the printing surface PF of the substrate S according to the embodiment is an example of a first surface of the substrate.

### Configuration Example of inkjet Printing Device

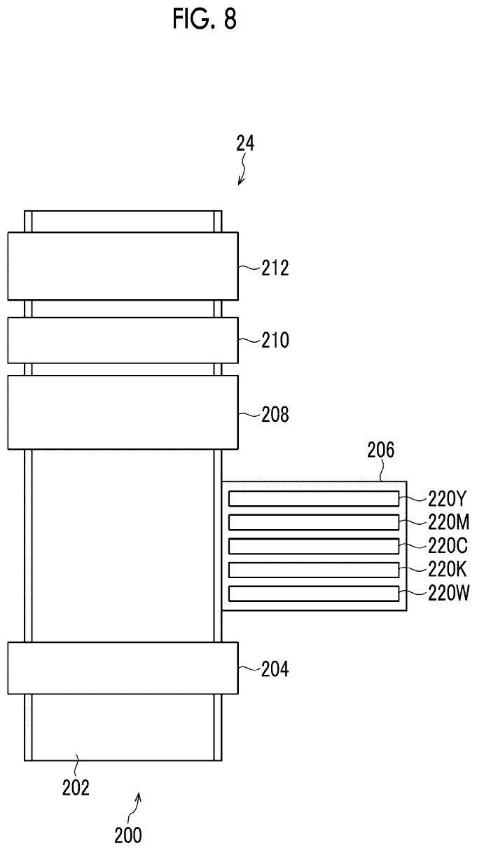

FIG. 8 is a configuration diagram of the inkjet printing device shown in FIG. 2 and the like. FIG. 8 shows the inkjet printing device 24 in a printing standby state. The inkjet printing device 24 prints the image on the printing surface PF of the substrate S by using the aqueous ink.

The inkjet printing device 24 comprises a printing transport device 200 to which a belt transport method of supporting and transporting the substrate S by using a transport belt 202 is applied. The transport belt 202 is endless, and is wound around a driving roller and a driven roller. In a case in which the driving roller is rotated in a specified direction, the transport belt 202 travels in the specified direction, and the substrate S supported by the transport belt 202 is transported in a specified transport direction. It should be noted that the driving roller and the driven roller are not shown.

The transport method of the printing transport device 200 is not limited to the belt transport method, and a transport method, such as a roller transport method, a nip transport method, or a drum transport method, may be applied.

The inkjet printing device 24 is supplied with the substrate S having the printing surface in which the aqueous sealer is applied to the printing surface PF and the undercoat layer in which the aqueous sealer is dried is formed. A posture is applied in which the surface of the substrate S, which is supplied to the inkjet printing device 24, on a side opposite to the printing surface on which the undercoat layer is formed is supported by the transport belt 202.

The printing transport device 200 comprises a carry-in section to which the substrate S carried out from the preceding device such as the substrate supply device 12 or the sanding device 18 shown in FIG. 2 is delivered. In addition, the printing transport device 200 comprises a carry-out section that carries out the substrate S to the device in the rear stage.

The inkjet printing device 24 comprises a pretreatment coater 204. The pretreatment coater 204 functions as the preconditioning liquid application device 20 and the preconditioning liquid drying device 22 shown in FIG. 2 and the like. The pretreatment coater 204 may be an external device of the inkjet printing device 24.

The inkjet printing device 24 comprises a head section 206. The head section 206 comprises an inkjet head 220W, an inkjet head 220K, an inkjet head 220C, an inkjet head 220M, and an inkjet head 220Y.

The head section 206 comprises a head movement section that supports an inkjet head 220W and the like and moves the inkjet head 220W and the like between a retreat position and a printing position. The head movement section may relatively move the substrate and the inkjet head 220W or the like to adjust a distance between the substrate and the inkjet head 220W and the like. The head movement section is not shown.

The inkjet head 220W jets a white ink. The inkjet head 220K jets a black ink. The inkjet head 220C jets a cyan ink. The inkjet head 220M jets a magenta ink. The inkjet head 220Y jets a yellow ink. For example, a Samba head manufactured by FUJIFILM Corporation may be applied as the inkjet head 220W and the like.

A single-pass method is applied to the inkjet printing device 24. That is, the inkjet printing device 24 comprises a line type inkjet head 220W and the like. The line type inkjet head has a structure in which a plurality of nozzle openings are formed over a length corresponding to the entire length of the substrate S in a width direction with respect to a width direction orthogonal to the transport direction of the substrate S.

The line type inkjet head may have a structure in which a plurality of head modules are connected in a longitudinal direction. The plurality of head modules may be connected in series as one example, or may be connected in a zigzag manner in two rows.

Multi-pass printing to which a serial method is applied may be applied to the inkjet printing device 24. A serial type inkjet head may be applied to the inkjet head 220W and the like.

In the inkjet printing device 24, in a case in which the line type inkjet head is provided and the single-pass printing is performed, relatively high productivity is implemented as compared with a case in which a serial type inkjet head is provided and the serial printing is performed. It should be noted that the inkjet head 220W and the like according to the embodiment are examples of an inkjet type jetting head. The white ink according to the embodiment is an example of a white ink.

Although FIG. 8 shows an aspect in which the inkjet head 220W that jets the white ink is provided, an aspect may be adopted in which the inkjet head 220W is not provided in a case in which the printing surface PF of the substrate S is the white base. Examples of the case in which the printing surface PF of the substrate S is the white base include a case in which the white coloring material particles are dispersed in the aqueous sealer and a case in which the white coloring material particles are dispersed in the preconditioning liquid.

The inkjet printing device 24 comprises an ink drying device 208. The ink drying device 208 shown in FIG. 8 functions as the ink drying device 26 shown in FIG. 2 and the like, and dries the aqueous ink jetted from the inkjet head 220W and the like and applied to the printing surface PF of the substrate S.

The ink drying device 208 may comprise a heater that heats the aqueous ink applied on the printing surface PF of the substrate S. An infrared heater may be applied to the heater. The infrared heater can be referred to as an IR heater. It should be noted that IR is an abbreviation for infrared.

The ink drying device 208 may comprise a blowing fan that blows air to the aqueous ink on the printing surface PF of the substrate S. The ink drying device 208 may be a combination of the heater and the blowing fan. In the ink drying device 208, the drying intensity is adjusted in accordance with the type of the substrate S and the type of the aqueous ink. Examples of the adjustment of the drying intensity include adjustment of a treatment temperature of the heater and adjustment of an air volume per unit time of the blowing fan.

The inkjet printing device 24 comprises a topcoat coater 210. The topcoat coater 210 functions as the topcoat liquid application device 28 shown in FIG. 2 and the like. A non-contact method such as a curtain flow method is applied to the topcoat coater 210, and the topcoat liquid is applied to the printing surface PF of the substrate S on which the printed image is printed.

The topcoat coater 210 may apply the topcoat liquid to an entire surface of the printing surface PF of the substrate S. The topcoat coater 210 may selectively apply the topcoat liquid to a part of the printing surface PF of the substrate S. Examples of the part of the printing surface PF of the substrate S include a region that excludes a region that is subjected to post-processing and removed from the substrate S.

The inkjet printing device 24 comprises a topcoat liquid drying device 212. The topcoat liquid drying device 212 functions as the topcoat liquid drying device 30 shown in FIG. 2 and the like, and dries the topcoat liquid applied on the printing surface PF of the substrate S to form the topcoat layer.

The topcoat liquid drying device 212 is provided with at least any one of the heater or the blowing fan, similarly to the ink drying device 208. In the topcoat liquid drying device 212, the drying intensity is adjusted in accordance with the type of the substrate S, the type of the aqueous ink, and the type of the topcoat liquid.

The substrate S, in which the drying treatment is performed on the printing surface PF of the substrate S on which the topcoat liquid is applied, is carried out from the carry-out section to the outside of the inkjet printing device 24 as the fiberboard structure.

FIG. 9 is a configuration diagram showing a printing state of the inkjet printing device shown in FIG. 8. FIG. 9 shows the printing state in which the printing is performed on a part of the printing surface PF of the substrate S.

In a standby state shown in FIG. 8, the inkjet head 220W and the like are disposed at a standby position deviated from a position directly above the transport belt 202. In the printing state shown in FIG. 9, the inkjet head 220W and the like is moved to the printing position directly above the transport belt 202 by using the head transport device, and is stopped.

The substrate S supported by the transport belt 202 is transported along a substrate transport direction in accordance with the traveling of the transport belt 202. The substrate transport direction is shown by using an arrow line. It should be noted that the substrate transport direction has the same meaning as the transport direction of the substrate S.

In a case in which the substrate S reaches the treatment region immediately below the pretreatment coater 204, the pretreatment coater 204 applies the preconditioning liquid to the entire surface of the printing surface PF of the substrate S and dries the applied preconditioning liquid.

In a case in which the substrate S on which the preconditioning liquid is applied reaches the treatment region directly below the inkjet head 220W, the inkjet head 220W jets the white ink onto the printing surface PF of the substrate S.

In a case in which the substrate S on which the preconditioning liquid is applied reaches the treatment region directly below each of the inkjet head 220K, the inkjet head 220C, the inkjet head 220M, and the inkjet head 220Y, the inkjet head 220K and the like jet the color ink onto the printing surface PF of the substrate S. In this manner, a color image in which the aqueous inks of white, black, cyan, magenta, and yellow are used is printed on the printing surface PF of the substrate S.

In a case in which the substrate S in which the color printed image is printed on the printing surface PF reaches the treatment region of the ink drying device 208, the printing surface PF of the substrate S on which the printed image is printed is subjected to the drying treatment.

In a case in which the substrate S in which the drying treatment is performed on the printing surface PF of the substrate S on which the printed image is printed reaches the treatment region of the topcoat coater 210, the topcoat liquid is applied to the printing surface PF of the substrate S on which the printed image is printed.

In a case in which the substrate S on which the preconditioning liquid is applied to the printing surface PF reaches the treatment region of the topcoat liquid drying device 212, the printing surface PF of the substrate S on which the topcoat liquid is applied is subjected to the drying treatment.

The substrate S that has passed through the treatment region of the topcoat liquid drying device 212 is carried out from the inkjet printing device 24 through the substrate carry-out section. The substrate S carried out from the inkjet printing device 24 is transported to the inspection device 32.

FIGS. 8 and 9 show examples of the inkjet printing device 24 that is provided with the pretreatment coater 204, the ink drying device 208, the topcoat coater 210, and the topcoat liquid drying device 212, but the pretreatment coater 204 and the like may be external devices of the inkjet printing device 24.

For example, the inkjet printing device 24 may be provided with the sealer application device 14 and the sealer drying device 16 in the preceding stage of the pretreatment coater 204. Further, the inkjet printing device 24 may be provided with the inspection device 32 in the rear stage of the topcoat liquid drying device 212.

### Specific Example of Fiberboard Structure

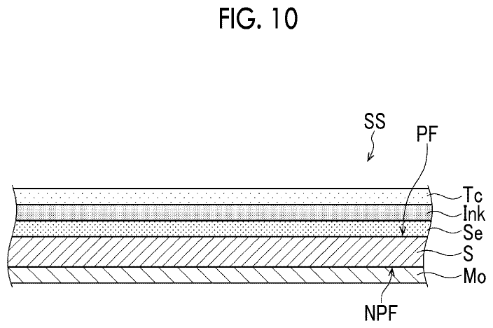

FIG. 10 is a cross-sectional view showing a structure example of the fiberboard structure. FIG. 10 shows a cross section of a fiberboard structure SS orthogonal to the printing surface PF of the substrate S. The substrate S is a wooden fiberboard itself, and an undercoat layer Se, an ink layer Ink, and a topcoat layer Tc are laminated in this order on the printing surface PF.

A moisture proof layer Mo is formed on a non-printing surface NPF of the substrate S opposite to the printing surface PF of the substrate S. The wooden fiberboard constituting the substrate S may deteriorate due to the absorption of moisture. Therefore, the moisture proof layer Mo may be formed in advance on the non-printing surface NPF of the substrate S.

For the formation of the moisture proof layer Mo, the attachment of a moisture proof sheet, such as a moisture proof film and moisture proof paper, to the non-printing surface NPF may be applied. The moisture proof layer Mo may be formed before the aqueous sealer is applied. The moisture proof layer Mo may be formed before the printing process is executed. The phrase “before the printing process is executed” may mean before the preconditioning liquid is applied. It should be noted that the non-printing surface NPF of the substrate S according to the embodiment is an example of a second surface of the substrate opposite to the first surface.

### Effects of Embodiment

The fiberboard structure manufacturing method, the fiberboard structure manufacturing system, and the fiberboard structure according to the embodiment can obtain the following operations and effects.
1

The aqueous sealer is applied to the printing surface PF of the substrate S to which the wooden fiberboard is applied, and the undercoat layer in which the aqueous sealer is dried is formed. The preconditioning liquid that reacts with the aqueous ink to thicken the aqueous ink is applied to the undercoat layer, and the inkjet type printing using the aqueous ink is executed on the printing surface PF of the substrate S on which the preconditioning liquid is applied.

The undercoat layer suppresses the infiltration of the ink into the substrate S, and thus the preferred color development of the ink is implemented. In addition, the preconditioning liquid immediately fixes the liquid droplets of the ink landed on the undercoat layer to the undercoat layer, and thus the deterioration in the quality of the printed image due to the misregistration of the ink dots is suppressed.
2

The aqueous sealer and the aqueous ink contain the same type of resin particles. As a result, the adhesiveness between the aqueous ink and the undercoat layer in which the aqueous sealer is dried can be relatively improved.
3

A volume of the aqueous sealer in a liquid state before the drying per unit area exceeds a volume of the aqueous ink in a liquid state before the drying per unit area. As a result, a thickness of the aqueous sealer is larger than a thickness of the aqueous ink, and the permeation of the aqueous ink into the substrate S is effectively suppressed.
4

The aqueous sealer contains the white coloring material particles. As a result, the printing of the image on the white base is implemented. In addition, a white object can be printed on a base of a color other than white.
5

The preconditioning liquid contains the white coloring material particles. As a result, a preferred white base can be formed even in a case in which the white base is not sufficient only with the undercoat layer of the aqueous sealer.
6

The inkjet printing device 24 comprises the inkjet head 220W that jets the white ink containing the white coloring material particles. As a result, the printing of the color image using the white ink as a base is implemented. In addition, the white object can be printed on the base of the color other than white.
7

The topcoat liquid is applied to the printing surface on which the image is printed by using the aqueous ink, and the applied topcoat liquid is dried. As a result, the rub resistance of the image printed by using the aqueous ink can be relatively improved.
8

In the application of the topcoat liquid, a non-contact process is applied. As a result, the rub resistance of the printed image printed by using the aqueous ink in a case in which the topcoat liquid is applied can be relatively improved.
9

The moisture proof layer Mo is formed on the non-printing surface NPF of the substrate S before the printing process. As a result, the deterioration of the substrate S due to the absorption of moisture in the substrate S is suppressed.
10

The printing surface PF of the substrate S is subjected to the sanding treatment. As a result, the fluff on the printing surface PF of the substrate S is removed, and the aqueous sealer can be uniformly applied.
11

The undercoat layer Se formed on the printing surface PF of the substrate S is subjected to the sanding treatment. As a result, a surface of the undercoat layer Se is smoothed, and the preconditioning liquid can be uniformly applied.

In the above-described embodiment of the present invention, the configuration requirements can be appropriately changed, added, or deleted without departing from the gist of the present invention. The present invention is not limited to the above-described embodiment, and various modifications can be made by a person having ordinary knowledge in the art within the technical idea of the present invention. In addition, the embodiment, the modification example, and the application example may be appropriately combined and carried out.

### EXPLANATION OF REFERENCES

10: fiberboard structure manufacturing system
12: substrate supply device
14: sealer application device
16: sealer drying device
18: sanding device
20: preconditioning liquid application device
22: preconditioning liquid drying device
24: inkjet printing device
26: ink drying device
28: topcoat liquid application device
30: topcoat liquid drying device
32: inspection device
34: fiberboard structure accommodation device
50: control device
52: system controller
54: data acquisition unit
56: parameter setting unit
58: sensor information acquisition unit
60: storage device
70: transport controller
72: transport device
74: sealer application controller
76: sealer drying controller
77: sanding controller
78: preconditioning liquid application controller
80: preconditioning liquid drying controller
82: printing controller
84: ink drying controller
86: topcoat liquid application controller
88: topcoat liquid drying controller
90: inspection controller
102: processor
104: computer-readable medium
106: communication interface
108: input/output interface
110: bus
112: input device
114: display
120: memory
122: storage
130: transport program
132: sealer application program
134: sealer drying program
136: sanding program
138: preconditioning liquid application program
140: preconditioning liquid drying program
142: printing program
144: ink drying program
146: topcoat liquid application program
148: topcoat liquid drying program
150: inspection program
200: printing transport device
202: transport belt
204: pretreatment coater
206: head section
208: ink drying device
210: topcoat coater
212: topcoat liquid drying device
220C: inkjet head
220K: inkjet head
220M: inkjet head
220W: inkjet head
220Y: inkjet head
Ink: ink layer
Mo: moisture proof layer
NPF: non-printing surface
PF: printing surface
S: substrate
Se: undercoat layer
Tc: topcoat layer
S10 to S28: each step of fiberboard structure manufacturing method

What is claimed is:

1. A fiberboard structure manufacturing method comprising:
forming an undercoat layer in which an aqueous sealer applied to a first surface of a substrate in which a fiberboard is used is dried, on the first surface;
applying an aqueous preconditioning liquid having a function of thickening an aqueous ink to the first surface on which the undercoat layer is formed; and
jetting the aqueous ink from an inkjet type jetting head to apply the aqueous ink to the first surface on which the aqueous preconditioning liquid is applied.

2. The fiberboard structure manufacturing method according to claim 1,
wherein the aqueous sealer and the aqueous ink contain the same type of resin.

3. The fiberboard structure manufacturing method according to claim 1,
wherein the aqueous sealer is applied to be thicker than the aqueous ink.

4. The fiberboard structure manufacturing method according to claim 1,
wherein the aqueous sealer contains white coloring material particles.

5. The fiberboard structure manufacturing method according to claim 1,
wherein the aqueous ink includes a white ink containing white coloring material particles, and
in the application of the aqueous ink, the white ink is applied to the first surface on which the aqueous preconditioning liquid is applied.

6. The fiberboard structure manufacturing method according to claim 1,
wherein a coating liquid is applied to the first surface on which the aqueous ink is applied.

7. The fiberboard structure manufacturing method according to claim 6,
wherein in the application of the coating liquid, a non-contact process is applied.

8. The fiberboard structure manufacturing method according to claim 1,
wherein a moisture proof layer is formed on a second surface of the substrate opposite to the first surface.

9. The fiberboard structure manufacturing method according to claim 1,
wherein the first surface of the substrate is subjected to a sanding treatment.

10. The fiberboard structure manufacturing method according to claim 1,
wherein the undercoat layer is formed on the first surface of the substrate by drying the aqueous sealer applied to the first surface of the substrate.

11. The fiberboard structure manufacturing method according to claim 1,
wherein the undercoat layer formed on the first surface of the substrate is subjected to a sanding treatment.

12. A fiberboard structure manufacturing system comprising:
a sealer application device that applies an aqueous sealer to a first surface of a substrate to which a fiberboard is applied;
a preconditioning liquid application device that applies an aqueous preconditioning liquid having a function of thickening an aqueous ink to the first surface on which an undercoat layer in which the aqueous sealer is dried is formed; and
an inkjet type jetting head that jets the aqueous ink to apply the aqueous ink to the first surface on which the aqueous preconditioning liquid is applied.

13. A fiberboard structure comprising:
a substrate to which a fiberboard is applied;
an undercoat layer in which an aqueous sealer applied to a first surface of the substrate is dried; and
an ink layer in which an aqueous ink applied to an aqueous preconditioning liquid, which is applied to the undercoat layer and has a function of thickening the aqueous ink, is thickened by reacting with the aqueous preconditioning liquid.
